(19) United States
(12) Patent Application Publication
(10) Pub. No.: US 2009/0205580 A1
(43) Pub. Date: Aug. 20, 2009

(54) Battery Operated Pet Toy

(76) Inventor: Simeon Tiefel, Stevensville, MT (US)

Correspondence Address: LAMORTE & ASSOCIATES P.C., P.O. BOX 434, YARDLEY, PA, 19067, US

(21) Appl. No.: 12/371,514

(22) Filed: Feb. 13, 2009

Related U.S. Application Data
(60) Provisional application No. 61/028,550, filed on Feb. 14, 2008.

(51) Int. Cl. A01K 29/00

(52) U.S. Cl. 119/708; 119/707

(57) ABSTRACT

The present invention is a pet toy assembly for use in playing with a pet, especially a cat. The pet toy assembly uses a pole with a handle at one end. A tether extends from the pole at the end opposite the handle. A motorized object is coupled to the tether so as to be suspended by the tether. The motorized object has a body and at least one appendage that extends from the body. The motor within the motorized object causes the appendage to wage or flap, thereby making the motorized object see=m alive to a pet. The motorized object is powered by batteries stored in the handle at the end of the pole. The power is transferred from the batteries to the motor in the motorized object through the structure of the tether.

### RELATED APPLICATIONS

This application is a continuation-in-part of Provisional Patent Application No. 61/028,550, filed Feb. 14, 2008 and entitled Battery Operated Pet Toy.

### BACKGROUND OF THE INVENTION

1. Field Of The Invention

In general, the present invention relates to toys and amusement devices where an object is tethered to a handle. More particularly, the present invention relates to toys for pets, where a tether is a wire that provides electrical power to an object that contains animation motors.

2. Prior Art Description

Many cat owners like to play with their cats. Playing with a cat stimulates the cat and provides the cat with exercise. Play between an owner and a cat also helps develop a bond between the owner and cat.

Cats have been domestic pets for thousands of years. In that long period of time countless toys and devices have been developed for use in playing with a cat. As many cat owners know, cats are instinctively attracted to most any small moving object that crosses the path of a cat. It is for this reason that a cat will chase and pounce upon the spot of a laser pointer directed against the floor. Recognizing this instinctive response in cats, many toys have been developed where a small object, such as a toy mouse, is placed at the end of a tether. The object can then be pulled or dangled across the path of a cat by pulling the tether.

A problem with tethered cat toys is that the object being pulled is inanimate. The movement of the object is caused by the pull of the tether. Accordingly, as soon as the tether is released, all movement in the object stops. As such, if a cat grabs the object, that object does not move in the cat's paws or mouth unless the tether is continuously pulled by the cat owner. Continuously tugging on a tether quickly becomes wearisome and reduces the amount of time an owner spends playing with his/her cat. As soon as owner stops tugging on the tether, the object stops moving and the cat quickly loses interest in that object.

In U.S. Pat. No. 5,146,702 to Belokin, entitled Display Having An Electric Motor For Simulating A Flying Object, an object is disclosed that is suspended at the end of a wire. The object is inanimate. However, the wire is attached to a large motor at its end opposite the object. The motor rotates and/or vibrates the wire. The movement of the wire causes the suspended object to move. A very similar device is disclosed in U.S. Pat. No. 5,823,844 to Markowitz, entitled Interactive Vibrating Toy.

Although prior art devices such as those shown in the Belokin patent and the Markowitz patent are very enticing for cats, they also can be dangerous to cats. Devices such as those shown in the Belokin patent and the Markowitz patent are connected to strong motors that never stop moving. As such, the suspended object can be yanked out of a cats mouth or twist into the fur of a cat, therein causing the cat physical pain and injury.

A need therefore exists for a tethered object cat toy that utilizes an object that moves under its own power to attract and keep the attention of a cat, yet is governed in its movements not to cause injury to the cat. This need is met by the present invention as described and claimed below.

### SUMMARY OF THE INVENTION

The present invention is a pet toy assembly for use in playing with a pet, especially a cat. The pet toy assembly uses a pole with a handle that is grasped by a user. A tether extends from the pole at the end opposite the handle. A motorized object is coupled to the tether so as to be suspended by the tether from the end of the pole. The motorized object has a body and at least one appendage that extends from the body. The motor within the motorized object causes the appendage to wave or flap, thereby making the motorized object seam alive to a pet.

The motorized object is powered by batteries stored in the handle at the end of the pole. The power is transferred from the batteries to the motor in the motorized object through the structure of the tether.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 is a perspective view of an exemplary embodiment of a pet toy assembly;

FIG. 2 is a partially exploded enlarged view of the tethered object used in the pet toy assembly;

FIG. 3 is a fully exploded view of the tethered object;

FIG. 4 is a cross-sectional view of the tethered object shown with wings up; and

FIG. 5 is a cross-sectional view of the tethered object shown with wings down.

### DETAILED DESCRIPTION OF THE DRAWINGS

Although the present invention pet toy assembly can be embodied in many ways, the embodiment illustrated shows a tethered object in the form of a butterfly. A butterfly is merely exemplary of a small object with moving appendages. A bird with wings, a fish with fins, or a mouse with moving legs could be used for the same purpose. The embodiment of a butterfly is selected in order to correspond to a model of the present invention currently being manufactured. The selected embodiment, however, is merely exemplary and should not be considered a limitation when interpreting the scope of the appended claims.

Referring to FIG. 1, an exemplary embodiment of a toy assembly 10 is shown. The toy assembly 10 is intended for use in playing with a pet, such as a cat. The toy assembly 10 has a handle 12, a pole 14, a flexible tether 16, and a suspended object 20.

The suspended object 20 contains at least one electric motor that causes the suspended object 20 to move when activated. In the shown embodiment, the suspended object 20 is configured as a butterfly 22. When activated, the butterfly 22 flutters its wings 24. As will later be described in more detail, the wings 24 of the butterfly 22 are soft. Furthermore, the power of the motor in the butterfly 22 is purposely limited. As such, the wings 24 will not move with sufficient force to injure a cat, even when the butterfly 22 is being held in the mouth of a cat.

The tether 16 extends from the suspended object 20. The tether 16 contains wires that carry electricity to the electric motor within the suspended object 20. The tether 16 itself may be a dual wire electrical cord. Alternatively, the tether 16 can contain insulated electrical wires sewn within a length of strapping or similar flexible band.

A pole 14 is provided. The pole 14 has a first end 25 and a second end 27. The pole 14 may be fixed in length. However, in the exemplary embodiment, the pole 14 is either telescoping or capable of being disassembled into parts. This enables the pole 14 to be sold in small packaging. The making of the pole 14 either as telescoping or in interconnecting parts also provides the pole 14 with the ability to be selectively adjustable in length between the first end 25 and the second end 27. The pole 14, when adjusted or assembled to its maximum length, has a length L1 longer than that of the tether 16. In this manner, a person lying on the ground can suspend the object 20 above the ground without having to lift the entire pole 14 off the ground.

In the shown embodiment, the pole 14 is comprised of at least two telescoping segments 28. Locking collars 29 are disposed on the pole 14 between telescoping segments 28. The locking collars 29 are used to interlock the various segments 28, therein allowing the pole 14 to be adjusted to a selected length.

The tether 16 extends into the first end 25 of a pole 14 and through the pole 14 toward the second end 27 of the pole 14. The handle 12 is connected to the second end 27 of the pole 14. The handle 12 defines a battery chamber 30 for holding at least one battery 32. The batteries 32 in the battery chamber 30 are used to supply power to the suspended object 20. The power is supplied through the structure of the tether 16. The handle 12 also contains an on/off switch 26 so that the suspended object 20 can be selectively activated and deactivated by a person grasping the handle 12.

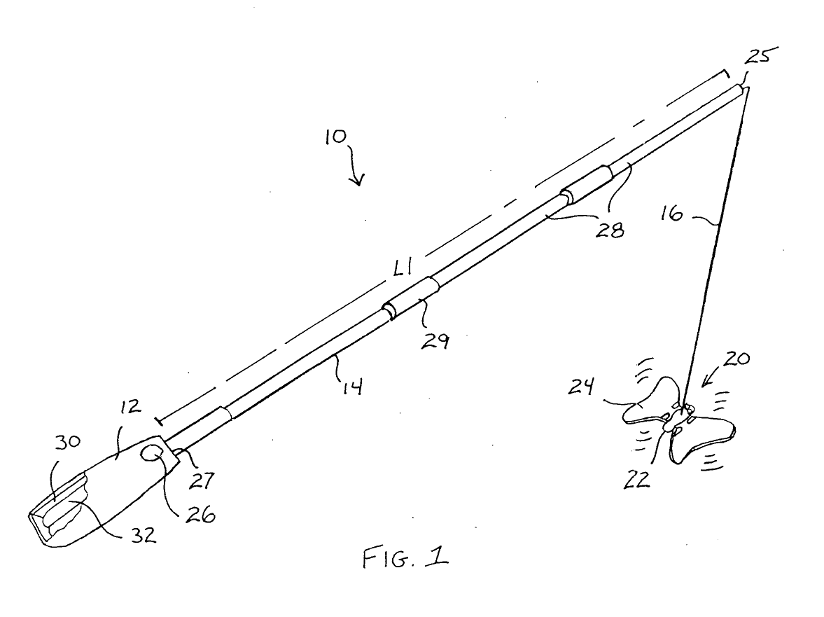

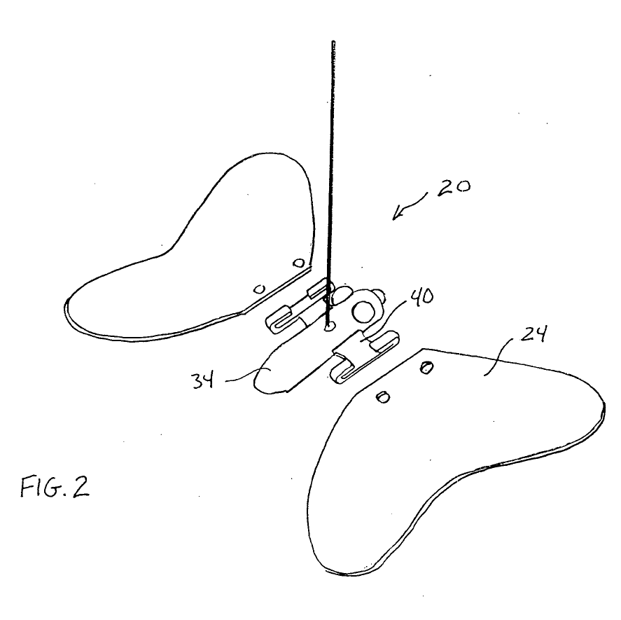

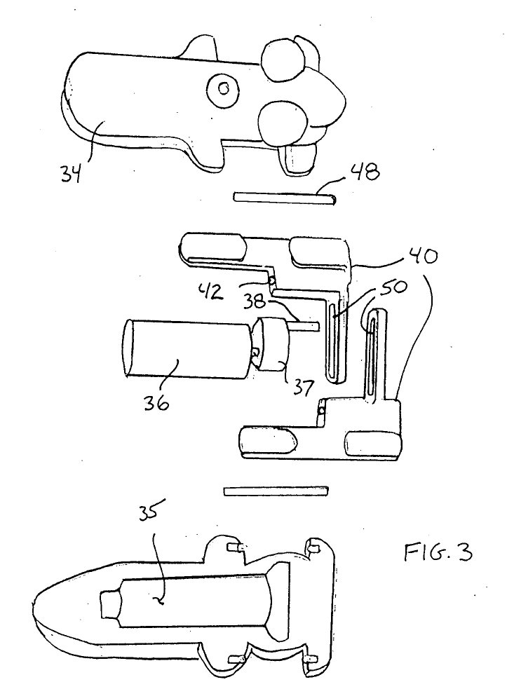

Referring to FIGS. 2 through 5, it can be seen that the suspended object 20 contains a rigid body housing 34 and soft wings 24. The wings 24 are preferably made of a plastic foam material or a pliable plastic so as to be semi-rigid but soft. In this manner, the wings 24 will not hurt any pet that may be impacted by the fluttering wings 24 or who may bite into the fluttering wings 24.

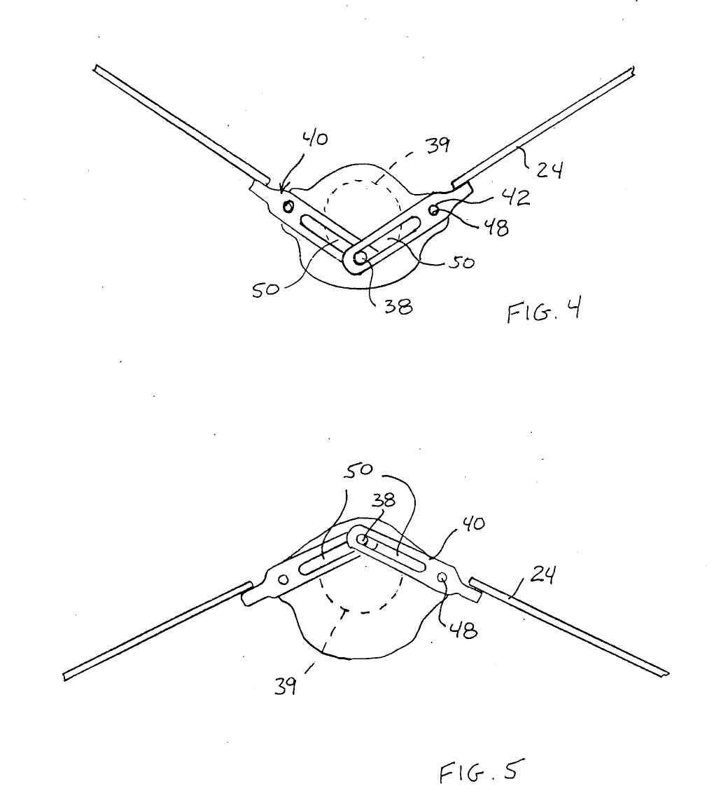

The rigid body housing 34 is made from molded plastic. The body housing 34 is hollow, therein defining an open interior 35. An electric motor 36 is disposed within the open interior 35 of the body housing 34. The electric motor 36 rotates a wheel 37 with an eccentric pin 38. Accordingly, when the electric motor 36 is activated, the wheel 37 spins and the pin 38 is repeatedly moved through a circular pathway 39 (FIG. 4).

Two rocking structures 40 are provided. Each rocking structure 40 defines a pin aperture 42 that extends through each rocking structure 40. Each rocking structure 40 has an arm section 44 on one side of the pin aperture 42 and an attachment section 46 on the opposite side of the pin aperture 42. Each rocking structure 40 is pivotally connected to the rigid body housing 34 with a pivot post 48 that extends through the pin aperture 42. This enables each rocking structure 40 to teeter about the pivot post 48.

Cam slots 50 are formed in the arm sections 44 of the rocking structure 40. The eccentric pin 38 rides within the cam slots 50. Accordingly, when the motor 36 is activated, the pin 38 moves in a circular pathway 39. As is indicated in FIG. 4, when the pin 38 is at a low point in the circular pathway 39, the arm sections 44 of the rocking structures 40 are driven downward. As is indicated in FIG. 5, when the pin 38 is at a high point in the circular pathway 39, the arm sections 44 of the rocking structures 40 are driven upward. This repeating movement causes the rocking structures 40 to pivot about the pivot posts 48 and create a flapping movement.

The wings 24 are connected to the attachment sections 46 of the rocking structures 40. Accordingly, when the motor 36 is activated, the wings 24 move with the rocking structure 40 and flap up and down. The overall butterfly 22, therefore, flutters and creates an object highly interesting to a cat.

The motor 36 used to create the flapping motion of the wings 24 is just strong enough to flap the soft foam wings 24 as long as the foam wings 24 are unencumbered. Should a cat or another pet grasp the suspended object in its mouth, the pressure of the mouth may temporarily stop the wings 24 and motor 36. The pet will feel the wings 24 trying to move, but the wings 24 will be unable to move with any force sufficient enough to harm the pet. However, as soon as the pet releases the suspended object 20 and the wings 24 are again unencumbered, the wings 24 will immediately begin to flap. The suspended device should, therefore, continue to hold the interest of the pet, even after it is caught and released by the pet.

Returning to FIG. 1, it will be understood that to use the toy assembly 10, the toy assembly 10 is held by the handle 12. The suspended object 20 is placed within reach of a pet and is selectively activated by pressing the on/off button 26 on the handle 12. When the object 20 is activated, the wings or other appendage flaps, therein making the object 20 seem alive. The object 20 is then brought into the range of a cat using the pole 14 and tether.

It will be understood that the embodiment of the present invention that is presented is merely exemplary and that a person skilled in the art can make many variations to that embodiment using functionally equivalent components. For instance, the illustrated pole can be replaced by any elongated structure. Likewise, the butterfly can be alternatively configured, as can the handle. Lastly, the tether can have many structures and can be either lengthened or shortened. All such variations, modifications, and alternate embodiments are intended to be included within the scope of the present invention as defined by the claims.

What is claimed is:

1. A pet toy assembly, comprising:
a pole having a first end, a second end and a predetermined length between said first end and said second end;
a flexible tether extending from said first end of said pole; and
a motorized object coupled to said tether, wherein said motorized object has a body, wings that extend from said body and an electric motor that causes said wings to flap when activated.

2. The assembly according to claim 1, wherein said electric motor in said motorized object receives electricity through said tether.

3. The assembly according to claim 2, further including a handle coupled to said second end of said pole, wherein said handle contains a battery compartment for holding batteries to power said motorized object.

4. The assembly according to claim 1, further including a pin that is rotated in a circular pathway by said electric motor.

5. The assembly according to claim 4, further including rocking structures that are pivotably connected to said body, wherein each of said rocking structures has an arm section that extends internally into said body and a wing attachment section that extends externally away from said body.

6. The assembly according to claim 5, wherein each said arm section defines a slot, wherein said pin extends into said slot and moves each said arm section as said pin rotates through said circular pathway.

7. The assembly according to claim 1, wherein said wings are constructed of a soft plastic foam.

8. The assembly according to claim 1, wherein said motorized object is configured as an insect.

9. The assembly according to claim 1, wherein said pole is selectively adjustable in length between said first end and said second end.

10. The assembly according to claim 1, wherein said tether has a length shorter than said pole.

11. A toy assembly, comprising:
an elongated pole having a first end and a second end and a predetermined length between said first end and said second end;
a flexible tether extending from said first end of said elongated pole, wherein said tether has a length shorter than said predetermined length of said pole; and
an animated object coupled to said tether, wherein said animated object has appendages and an electric motor that moves said appendages when activated.

12. The assembly according to claim 11, wherein said electric motor in said animated object receives electricity through said tether.

13. The assembly according to claim 12, further including a handle coupled to said second end of said pole, wherein said handle contains a battery compartment for holding batteries to power said animated object, and wherein said tether extends through said pole to said battery compartment.

14. The assembly according to claim 11, further including a pin that is rotated in a circular pathway by said electric motor.

15. The assembly according to claim 14, further including rocking structures that are pivotably connected to said animated object, wherein each of said rocking structures has an arm section that extends internally into said animated object and a wing attachment section that extend externally away from said animated object.

16. The assembly according to claim 15, wherein each said arm section defines a slot, wherein said pin extends into said slot and moves each said arm section as said pin rotates through said circular pathway.

17. The assembly according to claim 11, wherein said appendages are constructed of a soft plastic foam.

18. A pet toy assembly, comprising:
a body defining a hollow interior;
rocking structures that are pivotably connected to said body, wherein each of said rocking structures has an arm section with a slot that extends internally into said hollow interior of said body and an appendage attachment section that extends externally away from said body;
an electric motor disposed within said hollow interior, wherein said electric motor moves a pin through a circular pathway when activated, wherein said pin extends into each said slot and moves each said arm section as said pin rotates through said circular pathway; and
an appendage coupled to said appendage attachment section of each of said rocking structures.

19. The assembly according to claim 18, wherein said appendage is a wing.

20. The assembly according to claim 18, further including a battery housing for holding batteries, wherein said battery housing is remote from said body and coupled to said electric motor in said body by a flexible tether.
